(19) United States
(12) Patent Application Publication
(10) Pub. No.: US 2012/0168535 A1
(43) Pub. Date: Jul. 5, 2012

(54) TELESCOPIC WATER SPRAY TOOL

(76) Inventor: Andy CHEN, Greendale, WI (US)

(21) Appl. No.: 12/984,445

(22) Filed: Jan. 4, 2011

(51) Int. Cl. B05B 15/06

(52) U.S. Cl. 239/532

(57) ABSTRACT

A telescopic water spray tool includes a telescopic tube and a water delivering tube located in the telescopic tube. The telescopic tube includes an outer tube and an inner tube held in the outer tube and movable relative to the outer tube for a displacement to extend outside or retract inside the outer tube. The telescopic tube has a water inlet and a water outlet. The water delivering tube is located in the inner tube and has a first connecting section connected to the water inlet, a second connecting section connected to the water outlet, and a telescopic section bridging the first and second connecting sections. The telescopic section is extended and retracted with the inner tube in the displacement. Hence length of the telescopic tube is adjustable according to cleaning locations, and water in the telescopic tube is not spilled out through gaps between the inner and outer tubes.

### FIELD OF THE INVENTION

The present invention relates to a telescopic water spray tool and particularly to a water spray tool with an adjustable length.

### BACKGROUND OF THE INVENTION

Many water spray tasks, such as cleaning, irrigation and the like, are done through a water spray gun. In the event that the object of water spray task is located at a longer distance or a higher elevation, this is beyond the reach of the water spray gun, and to climb to a higher place to do the water spray task could meet danger easily, thus a water spray gun with an extension tube usually is employed to introduce the water to the higher place or longer distance before ejection, such as cleaning rain gutters, watering potted plants hung at a higher location, cleaning trees, washing large vehicles, and such. To facilitate the water spray gun to function at varying heights or distances, the extension tube usually is designed as a telescopic tube.

For instance, R.O.C. patent No. M313198 discloses a water spray telescopic tube fastening structure which includes an outer tube and an inner tube held in the outer tube. The outer tube has two ends coupled respectively with an upper retaining bushing and a lower retaining bushing. The inner tube has a retaining plug at one end inserted into the outer tube. The retaining plug is confined by the upper retaining bushing and lower retaining bushing when the inner tube is extended or retracted to prevent the inner tube from escaping the outer tube.

Another R.O.C. patent No. M329134 discloses a water spray apparatus connected to a water supply pipe. The water spray apparatus includes a telescopic tube with an adjustable length, a water spray head unit coupled with the top end of the telescopic tube, and a gripping unit at the bottom end of the telescopic tube. The telescopic tube has an outer tube, an inner tube axially inserted into the top end of the outer tube, and a coupling unit coupled with the top end of the outer tube and interposed between the inner tube and outer tube. The coupling unit is mounted on the junction of the inner and outer tubes and can be easily assembled and disassembled to facilitate disassembling and replacement of internal elements.

While the aforesaid water spray apparatus are respectively equipped with a telescopic tube, water is directly supplied to the telescopic tube, and flows through the outer tube and inner tube before ejection. The outer tube and inner tube are merely coupled with a washer between them to provide waterproof and sealing functions. Elastic fatigue easily takes place on the washer after being used for a long period of time, and the washer is also easily worn off due to friction during extension and retraction of the inner tube and outer tube and results in deficiency of waterproof function. Water leakage occurs when in use and results in waste of water resource. Users might also have their bodies wet because of the spilled water. Hence operation is troublesome. The outer tube and inner tube have to be disassembled frequently to replace the washer, thus more expense incurs due to the replacement of elements. Moreover, when the telescopic tube is in use or stored, any incidental impact could cause damage or fracture of the junction of the inner tube and outer tube, and result in water leakage problem. All these show that the conventional water spray apparatus still cannot fully meet users' requirements, and there are still rooms for improvement.

### SUMMARY OF THE INVENTION

The primary objective of the present invention is to solve the aforesaid disadvantages and prevent water from spilling out through the gap between the inner and outer tubes during extension and retraction of the telescopic tube.

To achieve the foregoing objective, the present invention provides a telescopic water spray tool which includes a telescopic tube and a water delivering tube. The telescopic tube includes an outer tube and an inner tube held in the outer tube and movable relative to the outer tube for a displacement to extend outside or retract inside the outer tube. The telescopic tube has a water inlet and a water outlet. The water delivering tube is located in the inner tube, and has a first connecting section connected to the water inlet, a second connecting section connected to the water outlet, and a telescopic section bridging the first connecting section and second connecting section. The telescopic section can be extended and retracted with the displacement of the inner tube. Thus forms the main structure of the invention.

In addition, in one embodiment of the invention, the telescopic section is a helical structure, and the water inlet and water outlet are located respectively at the outer tube and inner tube. The telescopic tube is connected to a water spray device at the water outlet. The outer tube and inner tube have respectively a first retaining portion and a second retaining portion to form a retaining relationship in the displacement. The outer tube further has a fastening element to provide a fastening force to confine the movement of the inner tube. The inner tube also has a holder to couple with an auxiliary cleaning tool such as a mirror, a brush and the like.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a sectional view of the invention.

FIG. 3 is another sectional view of the invention.

FIG. 4 is a schematic view of the invention in a use condition.

FIG. 5 is a perspective view of another embodiment of the invention.

### DETAILED DESCRIPTION OF THE PREFERRED EMBODIMENTS

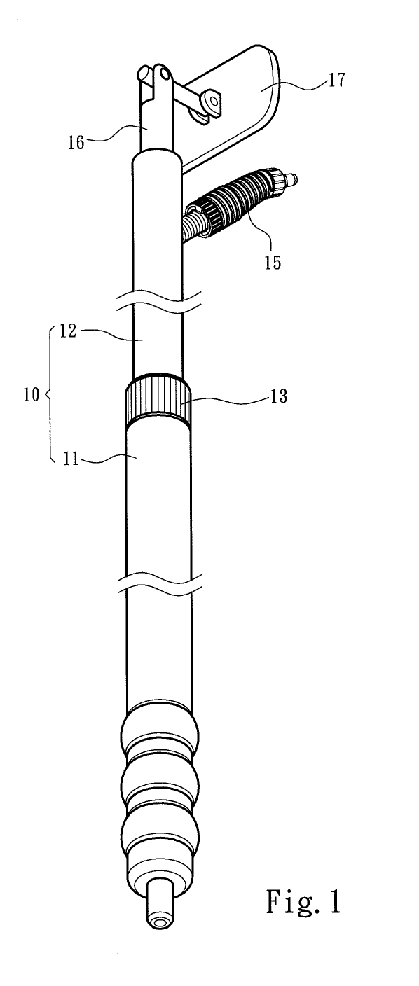

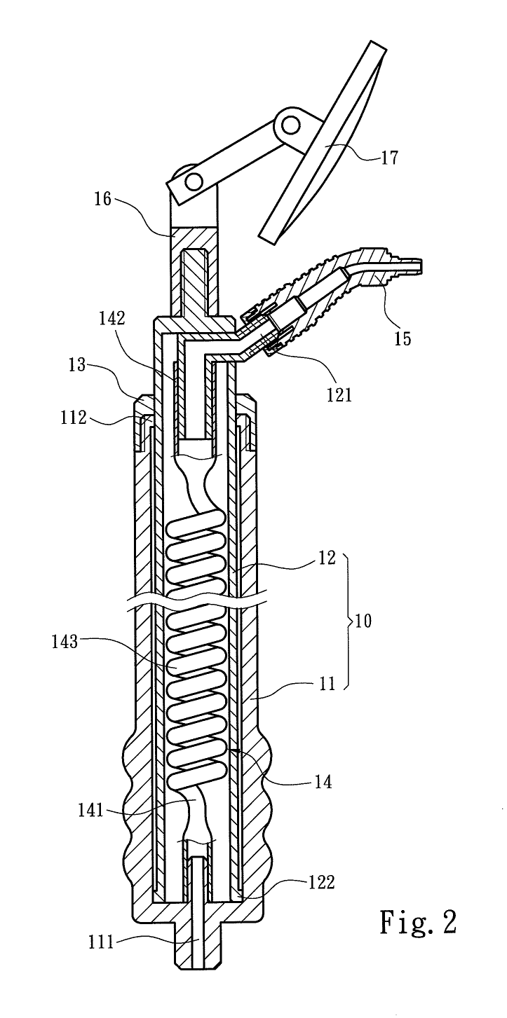

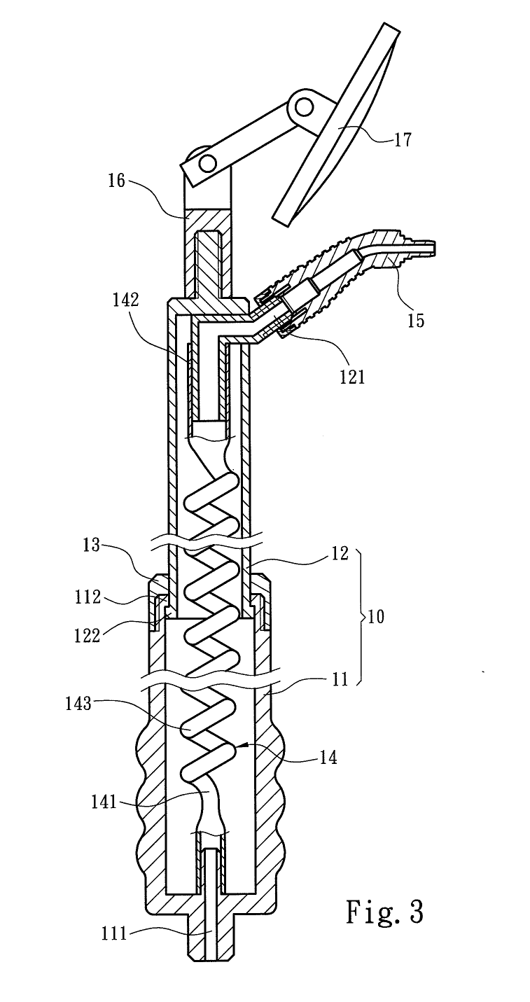

Please refer to FIGS. 1, 2 and 3, the present invention provides a telescopic water spray tool which mainly includes a telescopic tube 10 and a water delivering tube 14 located therein. The telescopic tube 10 includes a hollow outer tube 11 and an inner tube 12 held in the outer tube 12 and movable relative to the outer tube 11 for a displacement to extend outside or retract inside the outer tube 11. The outer tube 11 and inner tube 12 have respectively a first retaining portion 112 and a second retaining portion 122 that are mating flanges latched with each other to form a retaining relationship in the displacement of the inner tube 12 to prevent the inner tube 12 from escaping the outer tube 11. The outer tube 11 also has a fastening element 13 to provide a fastening force to confine the displacement of the inner tube 12 and hold the inner tube 12 and outer tube 11 in a fixed condition. The outer tube 11 has a water inlet 111 to receive water from an external source. The inner tube 12 has a water outlet 121 and a water spray device 15 at the water outlet 121 to spray the water received from the external source through the water inlet 111 to perform cleaning function.

The water delivering tube 14 is held in the inner tube 12, and has a first connecting section 141 at one end connected to the water inlet 111, a second connecting section 142 at another end connected to the water outlet 121, and a telescopic section 143 bridging the first and second connecting sections 141 and 142. As shown in the drawings, the telescopic section 143 is a helical structure. When the inner tube 12 is extended outside or retracted inside with the displacement of the outer tube 11, the telescopic section 143 can be driven by the inner tube 12 and extended or retracted through its own elasticity. The water from the external source flows through the water inlet 111 of the outer tube 11 to the first connecting section 141 of the water delivering tube 14, and passes through the telescopic section 143 to the second connecting section 142, and is sprayed through the water spray device 15 at the water outlet 121. Therefore, no water is spilled out through gaps between the inner tube 12 and outer tube 11 during water delivery.

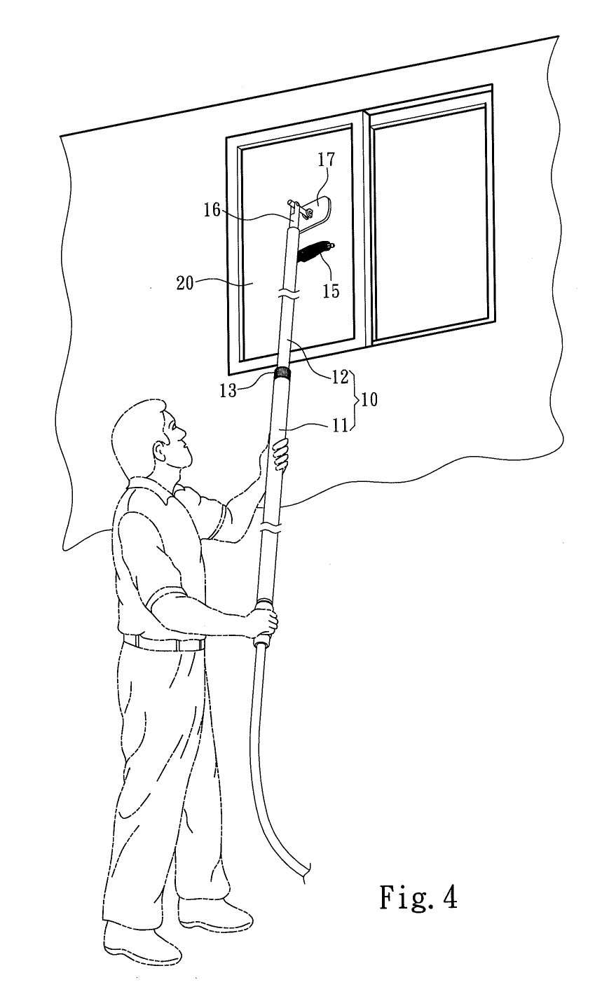

Also referring to FIG. 4, the telescopic water spray tool of the invention is used for cleaning at a higher location, such as a window 20 at the second floor of a house where performing cleaning by climbing to the roof is risky. The telescopic water spray tool of the invention can be employed to easily perform required cleaning by adjusting the telescopic tube 10 to a desired length to introduce water from the external source and spray the water through the water spray device 15 to clean dirt on the window 20. The inner tube 12 also has a holder 16 mounted thereon to couple with an auxiliary cleaning tool 17 to aid cleaning. In the drawings, the auxiliary cleaning tool 17 is a mirror to reflect blind spots invisible to the users, such as the tracks of the window 20, so that whether the window 20 has been cleaned thoroughly or clogged by fallen leaves can be easily seen.

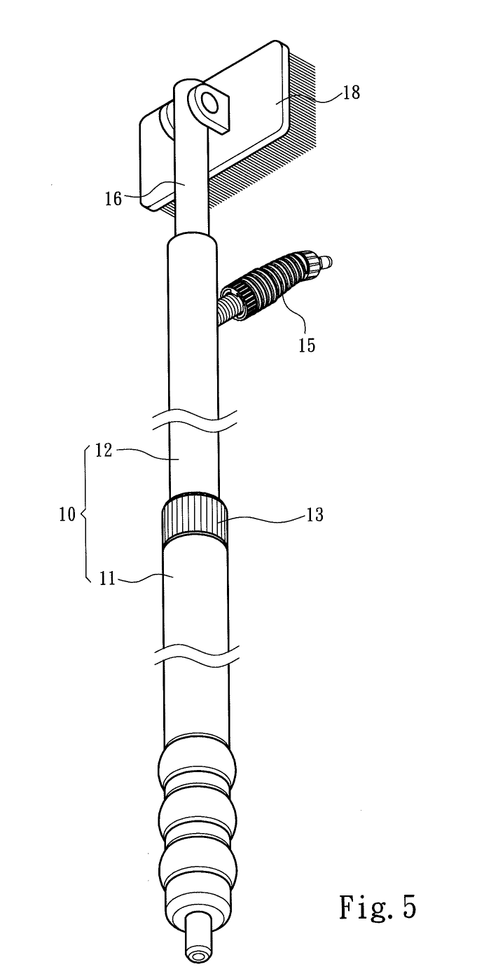

In addition, referring to FIG. 5, another auxiliary cleaning tool 18 such as a brush also can be installed to clean other spots or objects other than the window 20 at a higher location through the telescopic tube 10, such as exterior walls of houses, rain gutters, larger vehicles and such.

As a conclusion, the present invention mainly provides a water delivering tube 14 inside the telescopic tube 10 with the first connecting section 141 at one end connected to the water inlet 111 of the telescopic tube 10 and the second connecting section 142 connected to the water outlet 121 of the telescopic tube 10, and the telescopic section 143 bridging the first and second connecting sections 141 and 142. The telescopic section 143 can be driven by the telescopic tube 10 to extend outside or retract inside to adjust the length of the cleaning tool. Water is introduced through the water inlet 111 from the external source, and flows through the first connecting section 141, telescopic section 143 and second connecting section 142 to the water outlet 121 without being spilled out from the gaps between the outer tube 11 and inner tube 12 of the telescopic tube 10, thus usability improves and waste of water resource can be prevented.

While the preferred embodiments of the invention have been set forth for the purpose of disclosure, modifications of the disclosed embodiments of the invention as well as other embodiments thereof may occur to those skilled in the art.

Accordingly, the appended claims are intended to cover all embodiments which do not depart from the spirit and scope of the invention.

What is claimed is:

1. A telescopic water spray tool, comprising:
a telescopic tube which includes a hollow outer tube and an inner tube held in the outer tube and movable relative to the outer tube for a displacement to extend outside or retract inside the outer tube, the telescopic tube also including a water inlet and a water outlet; and
a water delivering tube which is located in the inner tube and includes a first connecting section connected to the water inlet, a second connecting section connected to the water outlet, and a telescopic section bridging the first connecting section and the second connecting section, the telescopic section being movable with the inner tube in the displacement thereof to extend or retract.

2. The telescopic water spray tool of claim 1, wherein the telescopic section is a helical structure.

3. The telescopic water spray tool of claim 1, wherein the outer tube includes a fastening element to provide a fastening force to confine the displacement of the inner tube.

4. The telescopic water spray tool of claim 1, wherein the telescopic tube is coupled with a water spray device at the water outlet.

5. The telescopic water spray tool of claim 1, wherein the water inlet and the water outlet are located respectively at the outer tube and the inner tube.

6. The telescopic water spray tool of claim 1, wherein the outer tube and the inner tube include respectively a first retaining portion and a second retaining portion to form a retaining relationship in the displacement.

7. The telescopic water spray tool of claim 6, wherein the first retaining portion and the second retaining portion are mating flanges latched with each other.

8. The telescopic water spray tool of claim 1, wherein the inner tube includes a holder to couple with an auxiliary cleaning tool.

9. The telescopic water spray tool of claim 8, wherein the auxiliary cleaning tool is a mirror.

10. The telescopic water spray tool of claim 8, wherein the auxiliary cleaning tool is a brush.
